(19) United States
(12) Patent Application Publication
(10) Pub. No.: US 2019/0182517 A1
(43) Pub. Date: Jun. 13, 2019

(54) Providing Enrichment Data That is a Video Segment

(71) Applicant: COMIGO LTD., Yarkona (IL)

(72) Inventor: Motty LENTZITZKY, Tel Aviv (IL)

(21) Appl. No.: 16/149,175

(22) Filed: Oct. 2, 2018

Related U.S. Application Data
(60) Provisional application No. 62/597,955, filed on Dec. 13, 2017.

(51) Int. Cl. H04N 21/234; H04N 21/235; H04N 21/84

(52) U.S. Cl. CPC H04N 21/23424; H04N 21/2353; H04N 21/25891; H04N 21/23418; H04N 21/84

(57) ABSTRACT

Methods and systems for enhancing the experience of users consuming content items. During the displaying of a content item by a user's content playing device, other content is determined as having a connection to the video content item, the other content including a video segment that is a portion of a strictly larger video content item. The video segment is retrieved, wherein the retrieving includes accessing the strictly larger video content item and reading the video segment from within the strictly larger video content item without reading other segments of the strictly larger video content item. The video segment is then played for the user by the content playing device.

### CROSS-REFERENCE TO RELATED APPLICATIONS

This patent application claims the benefit of U.S. Provisional Patent Application No. 62/597,955 filed on Dec. 13, 2017, which is incorporated herein by reference in its entirety.

### FIELD OF THE INVENTION

The present invention relates to systems and methods for enhancing user experience for a user consuming a content item, by playing a video segment having a connection with the content item. In particular, the present invention relates to playing, for enhancing user experience, video segments that are extracted from within larger video content items.

### BACKGROUND

When TV technology first became commercially available to the public, users could only consume video content items at their homes under fixed pre-determined schedules and in a linear way. That is—a user could only watch a movie or a news program at the time a broadcaster decided to broadcast it, and no deviation from the pre-defined program schedule was possible. The only flexibility a user had was the selection of which channel to display on one's TV screen, thus selecting between multiple video content items that are simultaneously aired.

At a later stage Video-On-Demand (VOD) was offered to the users. This service enabled them to consume content not appearing on the current programs schedule, and resulted in a significant increase in flexibility when deciding what to watch. Another boost in user flexibility was achieved when TV operators Introduced Catch-Up TV services which not only allow a user to pick any program recently offered in the EPG (Electronic Program Guide), but also allows him to jump backward and forward in time within a specific program and to freeze and resume the playing of a program.

The next step in the process of increasing user flexibility and freedom of choice was reached when some advanced Set-Top Boxes (STBs) started offering means for navigation between different media content items. For example, a user currently watching a movie which is about a crime mystery in Australia may ask the TV system to propose to him options for watching another media content item that is related to the currently watched movie or for watching other information related to that movie. He may then be presented with a list of options that includes:

a. One or more other crime mystery movies

b. One or more other movies with the plot occurring in Australia

c. One or more other movies having the same director as the current movie

d. One or more other movies with an actor or an actress that also appears in the current movie

e. A review of the current movie by the New York Times

f. A biography of the main actress of the current movie

g. A still picture of the main actress of the current movie

h. A graphic animation that is based on the plot of the current movie

The user can then select a member of the list and in response will be presented with the selected movie or with the selected other information.

This linking of media content items to related other media content items and/or to related other information brought user flexibility and freedom of choice to new levels not available before.

An additional improvement in that direction occurred when still more advanced STBs started proposing related media content items and related non-media content items that are not necessarily related to the currently played media content item as a whole, but are related to specific portions of a currently playing media content item or are related to specific entities appearing for a short period of time in a currently playing media content item. For example, a short appearance of a certain geographical location (for example the UN building in New York City) in a movie or in a news program may trigger the offering to the user of media content items and/or other information items that are related to that location. The user may for example be presented with a list of options that includes:

a. One or more movies whose plot (at least partially) occurs in the UN building.

b. One or more movies whose plot (at least partially) deals with diplomatic relations between states.

c. An article about the history of the UN organization.

d. A biography of the current General Secretary of the UN organization.

e. A still picture of the first General Secretary of the UN organization.

This linking of entities embedded within media content items to related media content items and/or to other types of related information brought user flexibility and freedom of choice to further new levels not available before.

The providing of recommendations for content items related to what a user is currently viewing is not limited to TV systems. With more and more content viewing moving from the TV screen to the computer screen and the phone screen, a similar development had occurred in the Internet browsing experience. In many websites (such as YouTube, CNN, Fox News), while a user is watching a content item, he sees recommendations for related content items.

The recommendations are presented in the form of hot links, that when selected by the user (for example by clicking them with a mouse), take the user to the linked content item. A link is typically shown together with a textual title (part or all of which may serve as the text acting as the hot link). For a video content item or a still picture content item, the link may also be shown together with a thumbnail image or with a small video window.

The recommendations may be for other content items in the same website, as is the case when other YouTube video content items are proposed during the watching of the currently watched YouTube video content item. Alternatively, the recommendations may include (or even consist only of) recommendations for other content items that are located in other websites. For example, some Internet news websites provide recommended links that are a mix of links to the same website as the currently watched content item and links to other news websites.

Regardless of the type of content item whose watching triggers the presentation of the recommendations (e.g. video, text) and regardless of the type of viewing device (e.g. TV screen, computer, phone), a triggered recommendation may point to a media content item (such as a video content item or a music content item) or to a non-media content item (such as a paragraph of text).

In prior art systems providing recommendations of related video content items while a currently playing content item is watched by the user, a link provided to a video content item points to a complete video content item. If, for example, the recommendation is for the movie “Lethal Weapon”, then selecting the link by the user causes playing that movie from its beginning to end (unless manually stopped by the user before reaching the end). In many scenarios, this does not address the user needs, as is shown by the following examples.

In a first example, the user is currently watching “Fast and Furious 8’ on his TV screen. The recommendations system learns there is a car chase in the currently watched movie (and may even detect this is the scene currently watched), and furthermore, concludes from that user's viewing history and manually-entered preferences that the user is fond of car chases. Consequently, the system recommends to the user several movies, each of which contains a car chase scene, with one of the recommendations being “Lethal Weapon 4”. When the user now selects the link to “Lethal Weapon 4”, that movie is played from its starting point. But in reality, what the user would prefer to watch is not the whole movie (which most probably he had already watched), but the car chase scene of the movie.

In a second example, the user is currently surfing the Internet, watching a YouTube short video on HALO (High-Altitude Low-Opening) parachuting. The recommendations system learns that fact, and also concludes from that user's viewing history and manually-entered preferences that the user is fond of HALO jumping. Consequently, the system recommends to the user several movies, each of which contains a HALO jumping scene, with one of the recommendations being the 1990 movie “Navy Seals”. When the user now selects the link to “Navy Seals”, that movie is played from its starting point. But in reality, what the user would prefer to watch is not the whole movie, but the HALO jumping scene of the movie.

There is thus a need to provide a user of a TV system or of the Internet with real-time video content item recommendations that have better resolution than recommendations for complete video content items.

### SUMMARY

A method is disclosed, according to embodiments, for enhancing user experience for a user consuming a content item. The method comprises (a) causing the content item to be displayed by a content playing device; and (b) during the displaying of the content item by the content playing device: (i) determining other content having a connection to the content item, where the determined other content includes a video segment that is a portion of a strictly larger video content item, and (ii) retrieving the video segment, wherein the retrieving includes accessing the strictly larger video content item and reading the video segment from within the strictly larger video content item without reading other segments of the strictly larger video content item. The method also comprises (c) causing the playing of the video segment by the content playing device.

In some embodiments, it can be that (i) the determining includes accessing a database that includes information about video segments that are portions of strictly larger video content items and content tags related to the video segments, and (ii) the connection of the video segment to the content item includes a connection between a content tag related to the video segment, and the content item.

In some embodiments, the method can additionally comprise (d) associating video segments of video content items included in a repository of video content items with content tags, each video segment being a portion of a strictly larger video content item included in the repository and (e) storing, in the database, results of the associating, the results including an association of the video segment with the content tag related to the video segment, wherein the displaying of the content item by the content playing device is subsequent to the associating and the storing.

In some embodiments, the content item can include a media content item. The media content item can include a video content item. In such case, the content-playing device can be selected from the group consisting of a television, a computer and a phone.

In some embodiments, the content item can include a non-media content item. The non-media content item can include a paragraph of text. In such a case, the content playing device can be selected from the group consisting of a computer and a phone.

In some embodiments, the connection of the video segment to the content item can be a connection of the video segment to the content item as a whole. In some embodiments, the connection of the video segment to the content item can be a connection of the video segment to a scene in the content item. In some embodiments, the connection of the video segment to the content item can be a connection of the video segment to a named entity identified in the content item.

In some embodiments, the determining of the other content having a connection to the content item can include analyzing a video channel of the content item. In some embodiments, the determining of the other content having a connection to the content item can include analyzing an audio channel of the content item. In some embodiments, the determining of the other content having a connection to the content item can include analyzing subtitles of the content item. In some embodiments, the determining of the other content having a connection to the content item can include analyzing metadata of the content item. In some embodiments, the determining of the other content having a connection to the content item can include analyzing text included in the content item. In some embodiments, the determining of the other content having a connection to the content item can be based on user preferences obtained by analyzing viewing history of the user. In some embodiments, the determining of the other content having a connection to the content item can be based on user preferences manually provided by the user.

In some embodiments, the playing of the video segment can be done while the content item is being displayed by the content playing device.

In some embodiments, it can be that for at least one point in time the content item and the video segment are simultaneously displayed.

In some embodiments, it can be that the content item is a video content item and the displaying of the content item is paused while the video segment is played.

In some embodiments, the method can additionally comprise (d) during the displaying of the content item by the content playing device, receiving a request from the user to propose enrichment data that is connected to the content item and (e) subsequent to the receiving of the request, presenting the user with an option to select the video segment, wherein the causing of the playing of the video segment is performed only in response to the user activating the option.

In some embodiments, the method can additionally comprise (d) during the displaying of the content item by the content playing device, presenting the user with an option to select the video segment, wherein the causing of the playing of the video segment is performed only in response to the user activating the option.

A system for distributing video content according to embodiments of the present invention, is disclosed herein. The system comprises (a) a content-item distribution module; (b) a visual-enrichment-data distribution module; (c) one or more computer processors; and (d) a non-transitory computer-readable storage medium storing program instructions for execution by the one or more computer processors, the non-transitory computer-readable storage medium having stored therein: (i) first program instructions that, when executed by the one or more processors, cause the content-item distribution module to cause the displaying of a content item by a content playing device; (ii) second program instructions that, when executed by the one or more processors, cause the visual-enrichment-data distribution module to determine, during the displaying of the content item by the content playing device, other content having a connection to the content item, where the determined other content includes a video segment that is a portion of a strictly larger video content item; (iii) third program instructions, that, when executed by the one or more processors, cause the visual-enrichment-data distribution module to retrieve the video segment, wherein the retrieving includes accessing the strictly larger video content item and reading the video segment from within the strictly larger video content item without reading other segments of the strictly larger video content item; and (iv) fourth program instructions that, when executed by the one or more processors, cause the visual-enrichment-data distribution module to cause the playing of the video segment by the content playing device.

In some embodiments, it can be that (i) the determining of the other content caused by the execution of the second program instructions includes accessing a database that includes information about video segments that are portions of strictly larger video content items and content tags related to the video segments, and (ii) the connection of the video segment to the content item includes a connection between a content tag related to the video segment, and the content item.

In some embodiments, the non-transitory computer-readable storage medium can additionally have stored therein (v) fifth program instructions that, when executed by the one or more processors, cause the visual-enrichment-data distribution module to associate video segments of video content items included in a repository of video content items with content tags, each video segment being a portion of a strictly larger video content item included in the repository, and (vi) sixth program instructions that, when executed by the one or more processors, cause the visual-enrichment-data distribution module to store, in the database, results of the associating, the results including an association of the video segment with the content tag related to the video segment, wherein the displaying of the content item by the content playing device caused by the execution of the first program instructions is subsequent to the associating and the storing caused by the execution of the fifth and sixth program instructions.

In some embodiments, the content item can include a media content item. The media content item can include a video content item. In such a case, the content playing device can be selected from the group consisting of a television, a computer and a phone.

In some embodiments, the content item can include a non-media content item. The non-media content item can include a paragraph of text. In such a case, the content playing device can be selected from the group consisting of a computer and a phone.

In some embodiments, the connection of the video segment to the content item can be a connection of the video segment to the content item as a whole. In some embodiments, the connection of the video segment to the content item can be a connection of the video segment to a scene in the content item. In some embodiments, the connection of the video segment to the content item can be a connection of the video segment to a named entity identified in the content item.

In some embodiments, the determining of the other content having a connection to the content item can include analyzing a video channel of the content item. In some embodiments, the determining of the other content having a connection to the content item can include analyzing an audio channel of the content item. In some embodiments, the determining of the other content having a connection to the content item can include analyzing subtitles of the content item. In some embodiments, the determining of the other content having a connection to the content item can include analyzing metadata of the content item. In some embodiments, the determining of the other content having a connection to the content item can include analyzing text included in the content item. In some embodiments, the determining of the other content having a connection to the content item can be based on user preferences obtained by analyzing viewing history of the user. In some embodiments, the determining of the other content having a connection to the content item can be based on user preferences manually provided by the user.

In some embodiments, the playing of the video segment can be done while the content item is being displayed by the content playing device. In some embodiments, it can be that for at least one point in time the content item and the video segment are simultaneously displayed. In some embodiments, it can be that the content item is a video content item and the displaying of the content item is paused while the video segment is played.

In some embodiments, the non-transitory computer-readable storage medium can additionally have stored therein (v) fifth program instructions that, when executed by the one or more processors cause the visual-enrichment-data distribution module to receive, during the displaying of the content item by the content playing device, a request from the user to propose enrichment data that is connected to the content item, and (vi) sixth program instructions that, when executed by the one or more processors cause the visual-enrichment-data distribution module to present the user, subsequent to the receiving of the request, with an option to select the video segment, wherein the playing of the video segment caused by the execution of the fourth program instructions is performed only in response to the user activating the option.

In some embodiments, the non-transitory computer-readable storage medium can additionally have stored therein (v) fifth program instructions that, when executed by the one or more processors cause the visual-enrichment-data distribution module to present the user, during the displaying of the content item by the content playing device, with an option to select the video segment, wherein the playing of the video segment caused by the execution of the fourth program instruction is performed only in response to the user activating the option.

### BRIEF DESCRIPTION OF THE DRAWINGS

FIG. 1 is a schematic illustration of a system for distributing content, causing the displaying of a video content item, and causing the playing of a video segment, according to embodiments.

FIG. 2 includes three schematic illustrations of video segments that are a portion of respective strictly larger video content items.

FIG. 3 shows a schematic illustration of two video segments that are a portion of a single strictly larger video content item.

FIG. 4A is a schematic illustration of a system for distributing content, wherein a visual-enrichment-data distribution module is in communication with an external repository of video items and a database of information about video segments and content tags, according to some embodiments.

FIG. 4B is a block diagram of the visual-enrichment-data distribution module of

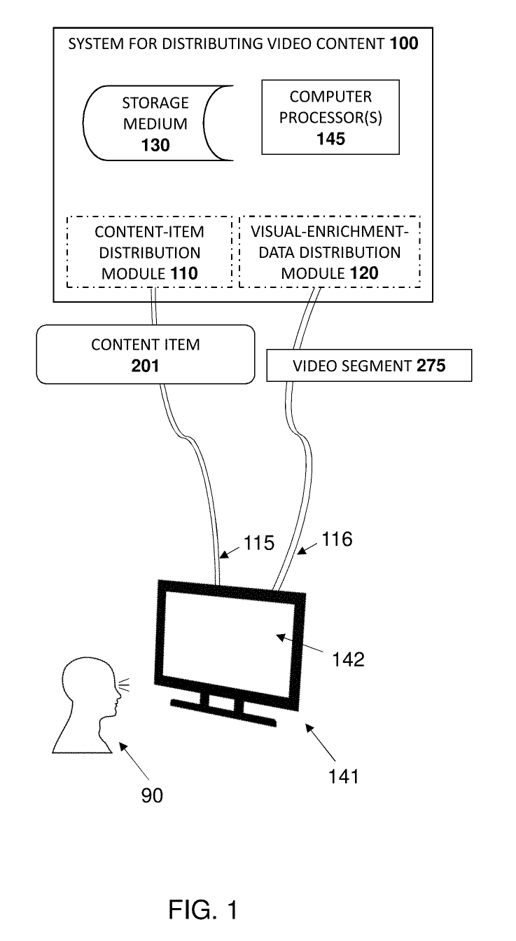

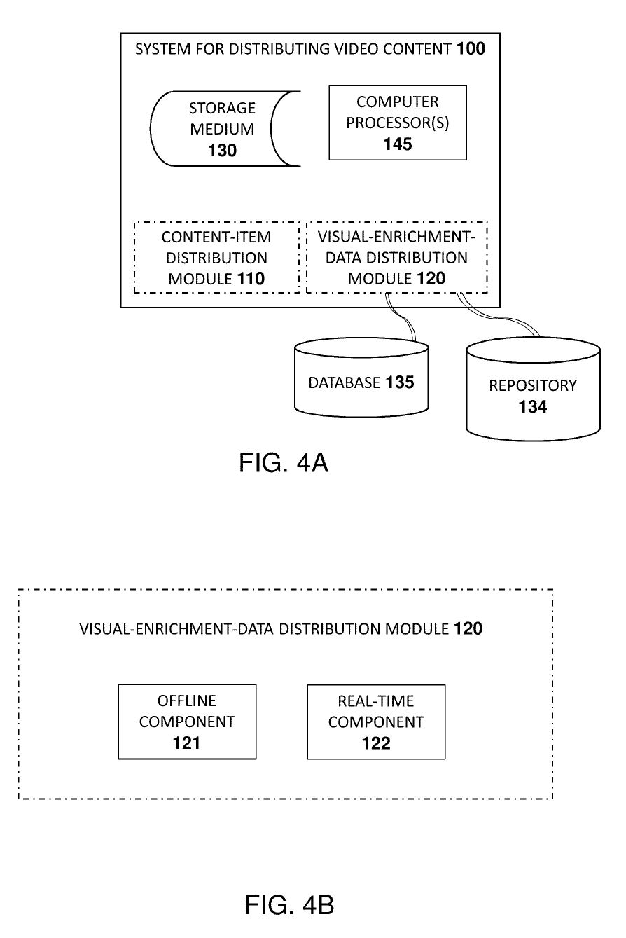

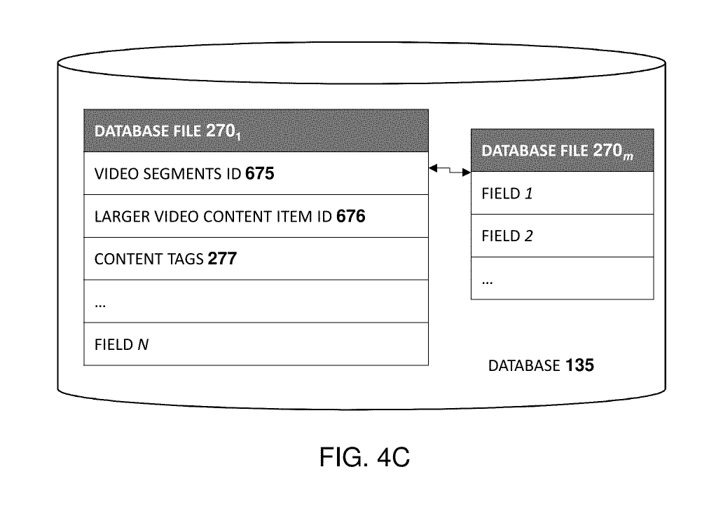

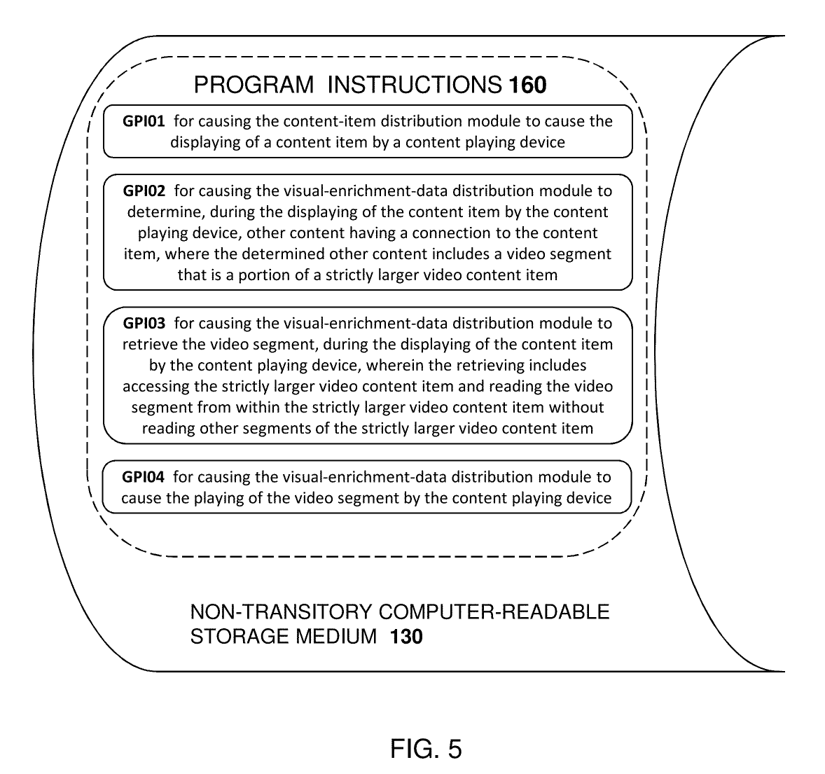

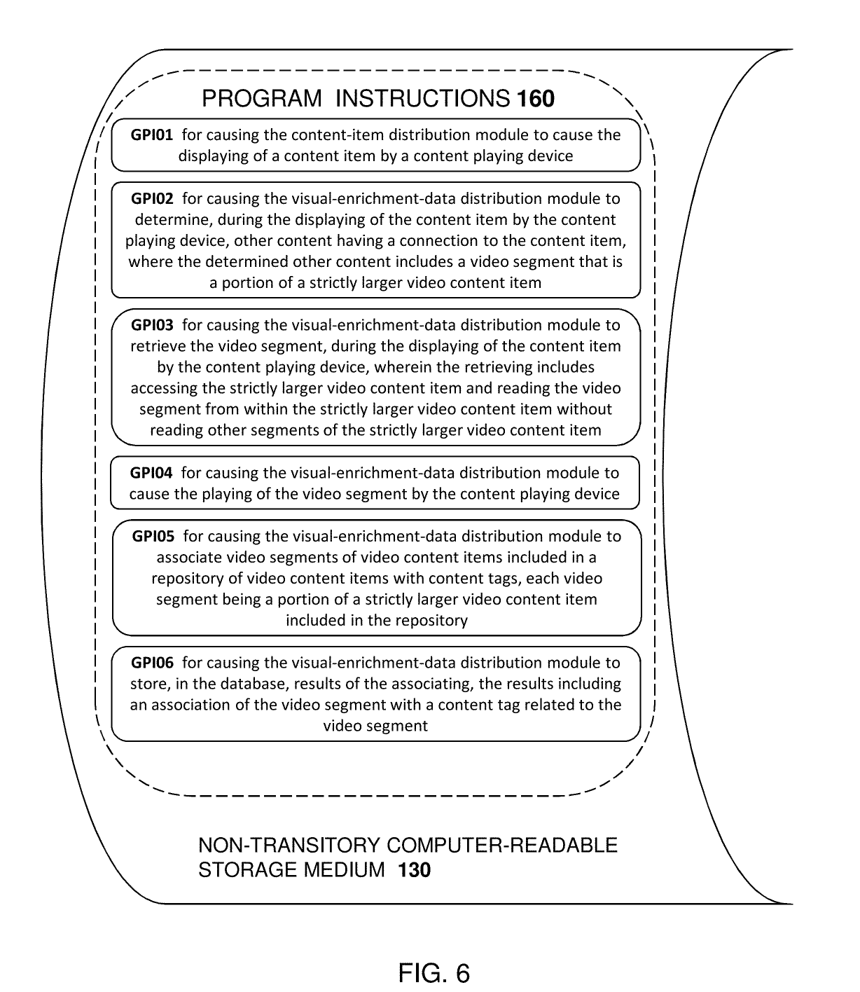

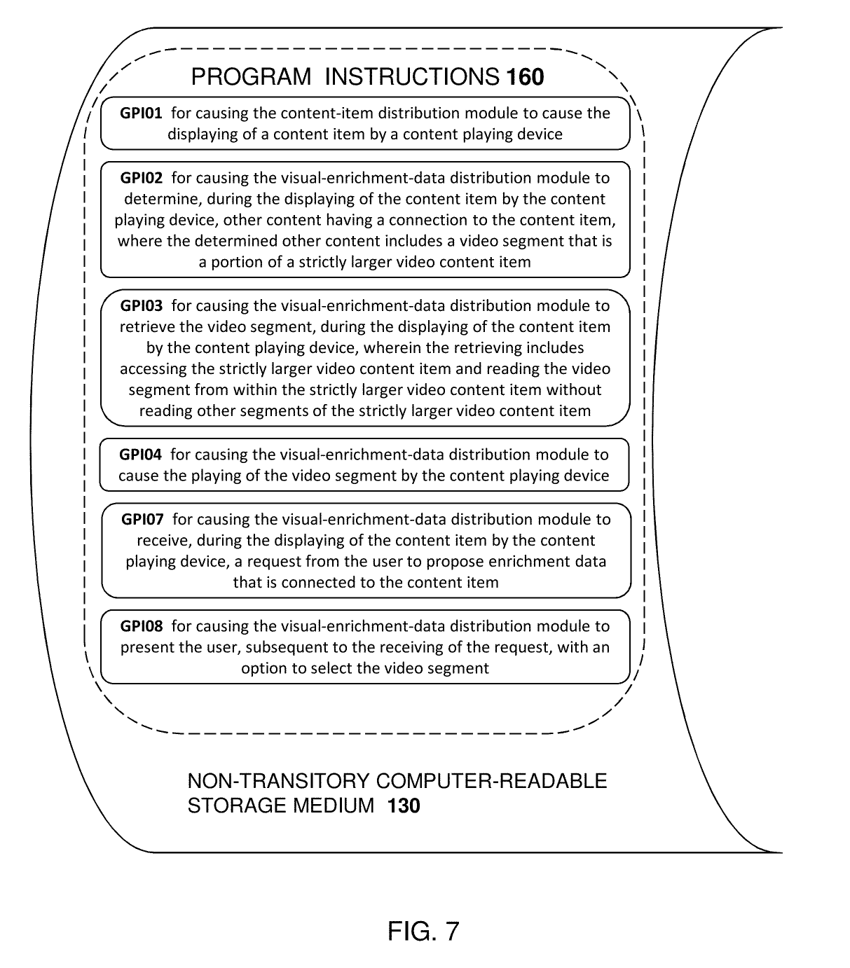

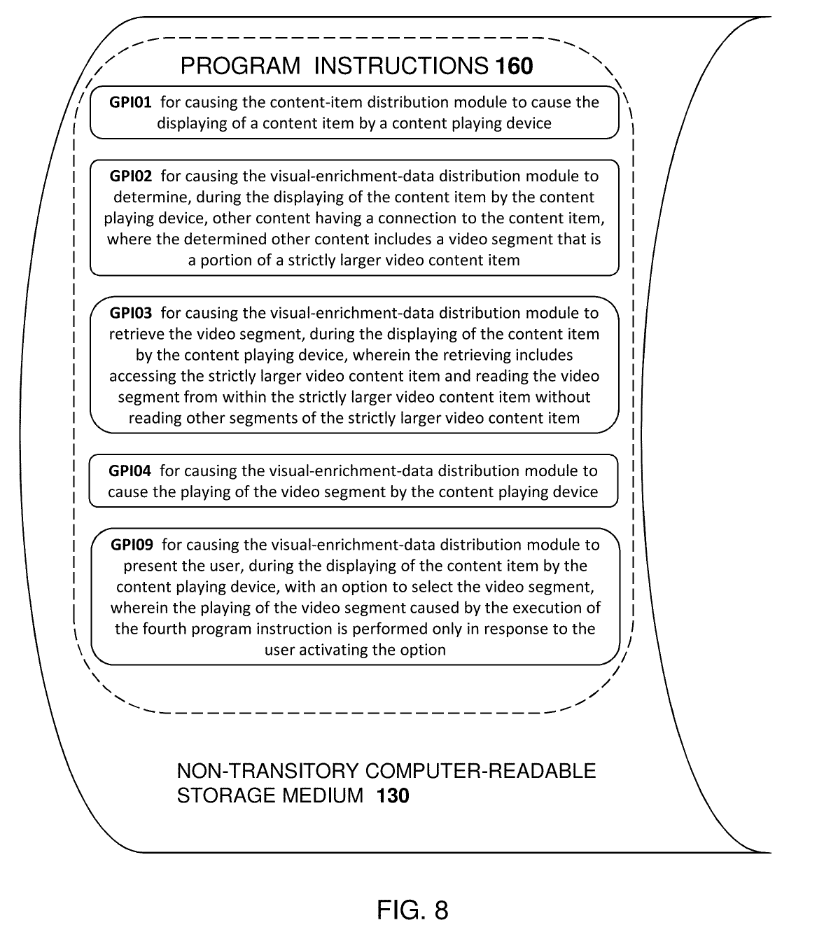

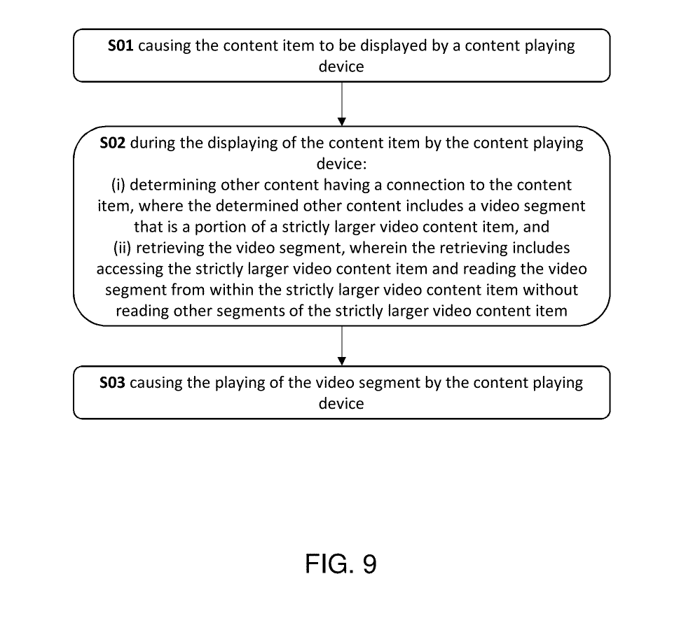

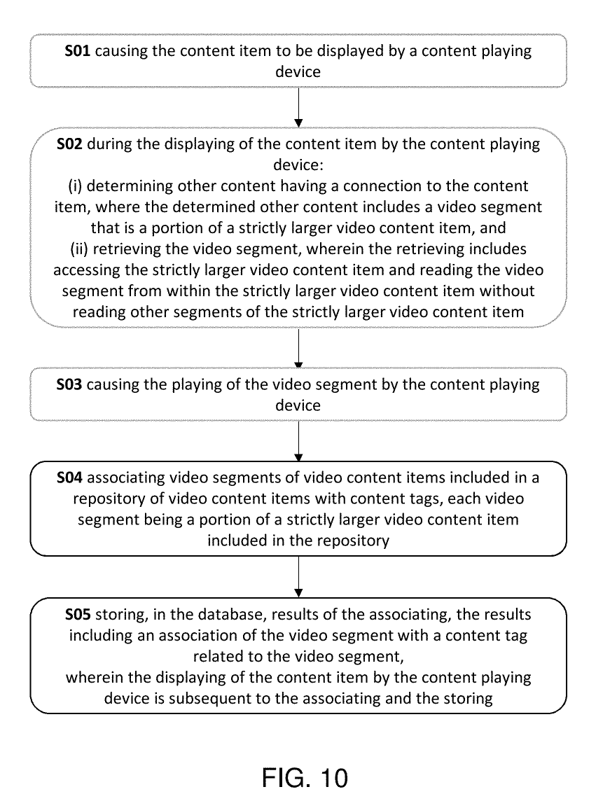

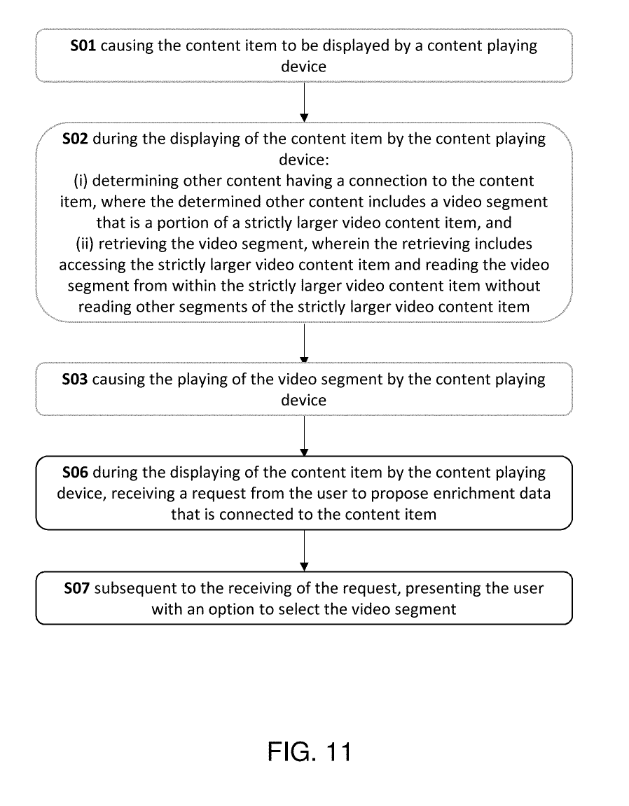

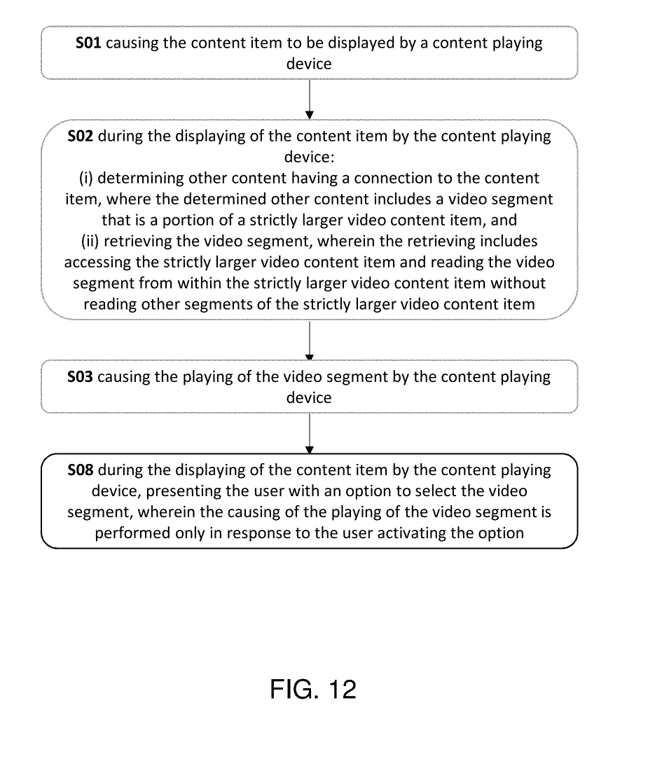

FIGS. 1 and 4A, showing offline and real-time components.

FIG. 4C shows an example of the database of FIG. 4A.

FIGS. 5, 6, 7 and 8 show schematic representations of computer-readable storage media and groups of program instructions stored thereon, according to some embodiments.

FIGS. 9, 10, 11 and 12 show flowcharts of methods for enhancing user experience for a user consuming a content item.

### DETAILED DESCRIPTION OF THE EMBODIMENTS

Note: Throughout this disclosure, subscripted reference numbers (e.g., 10₁) may be used to designate multiple separate appearances of elements in a single drawing, e.g. 10₁ is a single appearance (out of a plurality of appearances) of element 10. The same elements can alternatively be referred to without subscript (e.g., 10 and not 10₁) when not referring to a specific one of the multiple separate appearances.

According to the disclosed embodiments video content recommendations are provided to users of TV systems and to Internet surfers, where each recommendation may refer to a video segment which is a portion of a strictly larger video content item. The recommendations are related to content watched by the user at the time of providing the recommendations.

The disclosed system that also provides recommendations for video segments is advantageous over prior art video content recommendation systems that provide only recommendations for complete video content items. The recommendations are typically provided in the form of hot links, each selectable by the user using his GUI. Typically, a video recommendation link is accompanied by a thumbnail or by a small video window in which the recommended video is playing. Also typically, a video recommendation link is accompanied by a textual title, part or all of which may serve as the text acting as the hot link.

The implementation of the proposed system includes two parts—an offline component and a real-time component, the functioning of both of which is elaborated below.

The offline component identifies potentially interesting video segments ahead of time and stores pointers to them together with associated keywords and/or categories. The identifying of potential video segments is done over the space of video content that is available for providing recommendations to users.

For example, a TV operator providing a VOD service to its customers should apply this offline identifying step to all the movies (and other video content items) in his VOD library. Preferably, whenever a new video content item is added to the VOD library, it should be processed by the offline component of the proposed system in order to identify video segments that may be of interest to users at a later time.

As another example, an Internet content provider (e.g. a news website that collects its news items from multiple other news websites) should apply the offline component of the proposed solution continuously while monitoring the news websites that are its sources for new content. Every video content item posted by one of the source websites is processed immediately after being detected, so that all video segments that may be of interest to a user are identified and indexed.

Looking now at the “Lethal Weapon 4” example in the Background section, the offline component identifies the car chase scene as being a video segment of potential stand-alone interest to users, apart from the full movie. Consequently, the location of this video segment within the movie is recorded—the name and/or other identifier of the video content item (i.e. movie) containing it, its starting time within the movie and its ending time within the movie. Alternatively, instead of recording the ending time, the system may record the time length of the video segment. Additionally, the system records keywords and/or categories related to the video segment that will serve as tags to be searched in the future. In the present example, the system may associate the car chasing video segment with keywords such as “cars”, “car chase”, “Mel Gibson” and “Danny Glover”, and with category “police action”.

Similarly, for the “Navy Seals” example in the Background section, the offline component identifies the HALO jumping scene as being a video segment of potential stand-alone interest to users, apart from the full movie. Consequently, the location of this video segment is recorded, associated with keywords such as “high jumping”, “parachuting” and “navy seals”, and with category “military action”.
1. Automatically dividing a video content item into scenes is well known in the art. Examples of prior art algorithms for automatically dividing video content into video scenes appear in at least the following published references: Li, Ying & Narayanan, Shrikanth & Kuo, C.-C. Jay. (2004). Content-Based Movie Analysis and Indexing Based on AudioVisual Cues. Circuits and Systems for Video Technology, IEEE Transactions on. 14. 1073-1085. 10.1109/TCSVT.2004.831968.
2. Mandi, Walid & Ardabilian, Mohsen & M. Chen, L. (2000). Automatic video scene segmentation based on spatial-temporal clues and rhythm. Networking and Information Systems Journal—NIS.
3. Yong Rui, Thomas S. Huang, and Sharad Mehrotra. 1999. Constructing table-of-content for videos. Multimedia Syst. 7, 5 (September 1999), 359-368

A video segment that is identified by the proposed solution within an enclosing video content item may be a single video scene of that video content item. In such a case, any algorithm known in the art for identifying video scenes may be used for identifying video segments. But video segments of the disclosed system are not limited to being “natural” video scenes. For example, a video segment may be composed of a combination of two or more adjacent scenes that are associated with common keywords/categories. Alternatively, a video segment may be a portion of an enclosing scene that was identified as a scene by a scene-detecting algorithm. For example, a scene that includes a car chase may actually contain a first part including an initial hostile conversation between the drivers, followed by a second part including the actual car chase action. In such case the proposed solution may find the conversation part to be of no interest for users with an interest in car chases, and consequently only the second part will be tagged as a potentially recommended video segment associated with car chases.

The realization of the offline component can be located at a central location, i.e., not ‘client-side’, but rather ‘supplier-side’ or ‘server-side’ and is shared for the benefit of all users served by an operator or Internet service provider. For example, when used by a TV operator, the offline portion is implemented in one of the operator's sites which are serving its subscribers. The offline component can include creating and/or maintaining a database that warehouses the information assembled and maintained concerning, inter alia, video segments, their respective enclosing video content items, and keywords or content tags.

The real-time component of the proposed solution makes use of the information previously stored by the offline component in order to locate, select and present segment-resolution video recommendations to a user according to what he is currently watching and according to his preferences (i.e. manually-entered preferences or automatically-obtained (e.g., learned) preferences derived from his viewing history). The system monitors what the user is currently watching and looks for recommendations that might be of interest to him. The inputs for that determination may be any combination of the following:
i) Metadata of the currently watched content. This may include cast names, location of filming, location of plot, director name, genre, etc.
ii) Audio content of the currently watched content. This may include background noise (e.g. cheers of football fans, police sirens, car engine noise) and a soundtrack of people talking. In the latter case a speech-to-text conversion engine may be employed for extracting the spoken words. Named Entity Recognition (NER) and Named Entity Disambiguation (NED) engines may be employed for extracting named entities from the spoken words.
iii) Subtitles of the currently watched content. This may again include the use of NER and NED engines for extracting named entities from the subtitle text.
iv) Visual content of the currently watched content. This may require performing visual analysis of the visual content in order to identify people, locations, genre, etc. For example, when analyzing news items it may be possible (using OCR techniques) to identify names appearing on badges or on plaques placed in front of people, or to identify the text of street signs.

The real-time component may be located either in a central location (and shared by all users) or locally at each user's location.

The recommendations system has several modes of operation, which are selected by GUI components operated by the user:
A. The user may choose between “segments mode” in which a recommendation may point to a video segment enclosed within a larger video content item, and between a “full-items only” mode in which a recommendation may only point to a full video content item and not to a video segment.
B. The user may choose what types of associations are desired between recommended video content items and between the currently watched content. Any combination of the following types may be specified:
   a. A recommendation is associated with a named entity identified in the currently watched content
   b. A recommendation is associated with the currently watched content item as a whole
   c. A recommendation is associated with a segment in the currently watched content item

The choosing of the above modes and options may be implemented by multiple GUI components that may include two-state buttons, pairs of mutually-exclusive radio buttons, non-mutually-exclusive check boxes and the like.

The presenting of the recommendations and the playing of a recommendation may operate in any one of the following ways:
A. Recommendations are presented only if the user explicitly requests them (e.g. by pressing a button in his remote-control device), and a recommendation is played only if the user explicitly asks for playing it by selecting its link.
B. Recommendations are presented automatically without receiving an explicit user request, but a recommendation is played only if the user explicitly asks for playing it by selecting its link.
C. Recommendations are presented automatically without receiving an explicit user request, and a recommendation may be played automatically without the user explicitly asking for playing it.

The selection of which of the above operating modes will be used may be explicitly defined by the user using a GUI component (e.g. a group of three mutually-exclusive radio buttons). Alternatively, the selection may be set in advance by the vendor of the system.

It should be emphasized that a video segment extracted from its enclosing video content item and put back into a library or collection of video content items as a stand-alone item, is no longer considered to be a video segment and becomes a regular video content item. This is so even if the enclosing video content item from which the segment was taken is available in the same library. That is, a car chase scene extracted from a movie and posted in YouTube is no longer a video segment for the purpose of the present solution.

Referring now to the figures, and in particular to FIG. 1, a system 100 for distributing video content is illustrated, where the system 100 comprises a content-item distribution module 110, a visual-enrichment-data distribution module 120; one or more computer processors 145, and a non-transitory computer-readable storage medium 130 storing program instructions 160 (not shown in FIG. 1). Examples of stored program instructions 160 are shown in FIGS. 5-8 and are discussed later in this disclosure. Both the content-item distribution module 110 and the visual-enrichment-data distribution module 120 are in at least indirect communication via respective communications channels 115, 116 with a content-playing device 141 of a user 90. The content-playing device can be any content-playing device 141 having a screen 142 for displaying content, including video content, such as, for example, a television, a computer (desktop, notebook, tablet, etc.) or a smartphone. Communications channels 115, 116 can include any communications technology known in the art for delivering video content and related content, whether wired or wireless or both, and including, but not exhaustively, over-the-air broadcast television systems, cable television systems, over-the-Internet television systems (e.g. IPTV or OTT), and satellite televisions systems. Content-item distribution module 110 is operable to deliver a content item 201, for example according to a schedule or on-demand, to the user's content-playing device 141. The expression “deliver to the content-displaying device 141” as used herein or any conjugate thereof means that that the content item 201 is caused to be displayed on the content-playing device 141. Visual-enrichment-data distribution module 120 is operable to deliver a visual enrichment data 275 to the user's content-playing device 141, for example upon user request as described earlier in this disclosure.

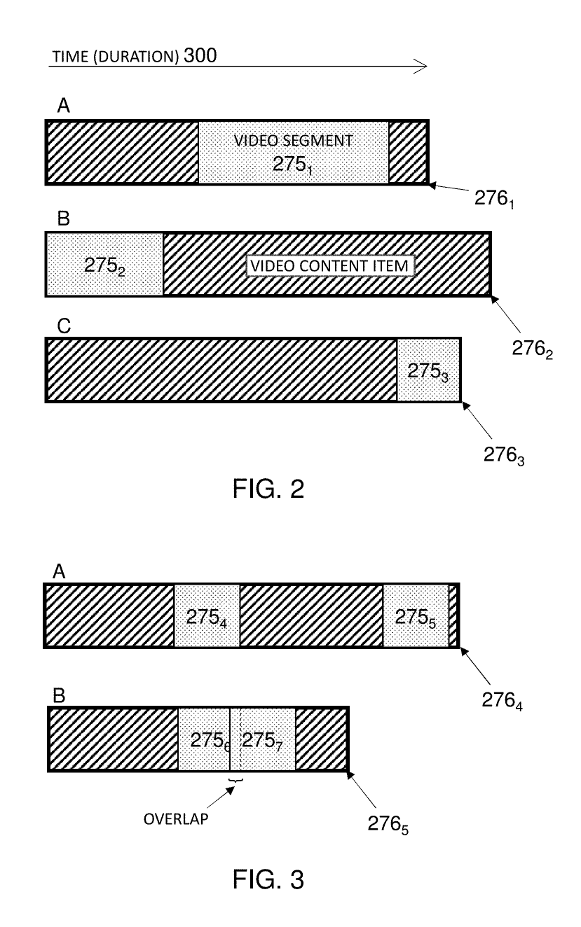

FIG. 2 illustrates the relationship between the concepts of video content item and video segment as used herein. Arrow 300 indicates the dimension of time (duration) of the respective elements in the figure. A video segment 275 is a proper subset of a full video content item 276, i.e., the video segment 275 is part of a full video content item 276 that is strictly larger (i.e., longer) than the video segment 275. A video segment 275 can appear at the beginning or end of a full video content item 276, or anywhere within its duration. In Part A, a full video content item 2761 is illustrated as including a video segment 2751 that starts after the beginning of video content item 2761 and finishes before its end. In Part B, a second full video content item 2762 is illustrated as including a second video segment 2752 that starts at the beginning of video content item 2762 and finishes before its end. In Part C, a third full video content item 2763 is illustrated as including a further different video segment 2753, which starts near the end of full video content item 2763 and continues until its end. FIG. 3 shows that a single full video content item 276 can include multiple video segments 275. The multiple video segments 275 can be contiguous or non-contiguous, and can be overlapping, for example when a first video segment 275 is connected to a first keyword or content tag, and a second video segment 275 that overlaps the first is connected to a second keyword or content tag. In Part A, full video content item 276₄ includes two non-contiguous video segments 275₄ and 275₅. In Part B, full video content item 276₅ include two overlapping video segments 275₆ and 275₇, the overlap being represented in FIG. 3 as the duration between the beginning of video segment 275₇ (solid line) and the end of video segment 275₆ (dashed line). It will be obvious from the foregoing discussion that a single video content item 276 can include any number of video segments 275.

Reference is made to FIG. 4A. The system 100 for distributing video content shown earlier in FIG. 1 is shown again, with the visual-enrichment-data distribution module 120 being in data communication with a repository 134 of video content items. A repository can include a collection of video content items that is available to the system 100, both for indexing and searching of video segments of potential interest to users of system 100, and for retrieving therefrom video segments for enhancing the user's experience. One example of a repository 134 is the collection of all the video content items available for streaming and/or downloading through a specific Internet site offering downloads and/or streams of video content items. Another example is the collection of video content items available for streaming in the VOD offering of the operator of the system 100. A repository 134 may alternatively include multiple collections or parts of multiple collections; for example, it can include both the Internet site's collection and the VOD collection of the two previous examples, or for a given user it can include both the Internet site's collection and the VOD collection of the two previous examples, but only that pat of the VOD collection which is ‘family-friendly’ or not R-rated.

In FIG. 4B, it can be seen that a visual-enrichment-data distribution module 120 can include an offline component 121 and a real-time component 122. The operation of the offline component 121 is generally not visible to users 90, while the real-time component 122 is the component that accepts user inputs, determines or selects relevant additional content (e.g., video segments 275) and causes them to be played. In embodiments, the offline component 121 of visual-enrichment-data distribution module 120 can index the repository 134 of video content items, or portions thereof, so as to associate video segments within the video content items with content tags (the term being used interchangeably herein with ‘keywords’). The visual-enrichment-data distribution module 120 can further store an index of video segments and associated content tags based on the indexing, in a database. Still referring to FIG. 4A, a database 135 in data communication with the visual-enrichment-data distribution module 120 is shown. The database 135 can include such an index of video segments and associated content tags. The database 135 can be stored in a non-transitory computer-readable storage medium, and can preferably be located in the supplier-side, i.e., in a central location that can be accessed by the visual-enrichment-data distribution module 120 for some, many, or all of its connected users 90.

FIG. 4C shows a diagram of a non-limiting illustrative example of a database 135. It is noted that in some relational database environments, such as, for example, in Microsoft Access®, a single database file can include, aggregated within it, multiple related tables. In other database environments, such as typical SQL applications, each table can be in a separate file. The latter convention is used in this discussion and reference is made to database files 270, but alternatively multiple ‘database files 270’ can be understood as meaning ‘multiple tables 270 within a single aggregating file’ if the database 135 uses the former convention. As shown in FIG. 4C, a first database file 270₁ can include a number of data fields such as a unique identifier 675 for video segment 275, a unique identifier 676 for the respective larger video content items 276 in which video segment 275 is found, location of video segment 275 within its respective larger video content item 276, content tags 277 that are associated with respective video segment 275, and whatever other fields might be deemed useful. The database 135 can include up to m-1 database files 270₂ . . . 270ₘ (i.e., in addition to the first database file 270₁), only one of which—270ₘ—is illustrated, and in a relational database as is known in the art, each ith file 270ᵢ can have a linkage to at least one other file. For example, a linked file 270ᵢ can have additional information about a video content item 276 that appears in a record in the first file 270₁ as being the ‘including video content item’ of a video segment. The fields and tables/files illustrated in FIG. 4C are for illustration and any arrangement of information can be implemented in a database 135.

The visual-enrichment-data distribution module 120 can maintain and update the database 135 at any time. Maintaining and updating the database can include any type of database maintenance activity such as (and not exhaustively): re-indexing the video content items 276 of a repository 134 or a portion thereof, for example after adding or removing video content items 276 from the repository 134, or re-indexing the video content items 276 of a repository 134 after adding new types of content tags. The database 135 can be updated or maintained at any time, on a regular basis or on an irregular basis, and the approach to updating can change from time to time. In any case, the visual-enrichment-data distribution module 120 can use whatever information is in the database 135 at the time that the real-time component 122 is operable to determine and retrieve additional content with a connection to a content item being displayed on a content playing device 141. Thus, the creating and maintaining of a database by the offline component would have been performed before any specific instance of real-time determining of other content (i.e, retrievable video segments) with a connection to the currently displayed content item. However, because the database can always be further updated based on changes in a repository of video content items, it can happen, for example, that a user is offered a video segment in the afternoon that wasn't available in the morning.

The selection of content having a connection to a content item 201 being displayed on a content playing device 141 can be performed by matching one or more content tags related to the content item 201 with information (e.g., a content tag) in the database 135. A content tag related to content item 201 may be related to content item 201 as a whole, to a video scene of content item 201, or to a named entity identified (e.g. by real-time components 122) to appear in content item 201.

We now refer to FIG. 5 in combination with FIG. 1. The system 100 for distributing video content, according to some embodiments, comprises a video-content-item distribution module 110, a visual-enrichment-data distribution module 120, one or more computer processors 145, and storage medium 130, which is a non-transitory, computer-readable medium. The one or more computer processors 145 are operative to execute program instructions 160 stored in the storage medium 130. The program instructions 160, which are represented schematically in FIG. 5, include four groups of program instructions: GPI01, GPI02, GPI03 and GPI04, where each group of instructions GPI01 . . . GPI04 includes program instructions for carrying out a portion of a method. The four groups comprise:
a. Group of program instructions GPI01 including program instructions for causing the video-content-item distribution module 110 to cause the displaying of a content item 201 by a content playing device 141.
b. Group of program instructions GPI02 including program instructions for causing the visual-enrichment-data distribution module 120 to determine, during the displaying of the content item 201 by the content playing device 141, other content having a connection to the content item 201, where the determined other content includes a video segment 275 that is a portion of a strictly larger video content item 276.
In some embodiments, the determining of the other content includes accessing a database 135 that includes information about video segments 275 that are portions of strictly larger video content items 276 and content tags 277 related to the video segments 275. In some embodiments, the connection of a video segment 275 to the content item 201 includes a connection between a content tag 277 related to the video segment 275, and to the content item 201.
c. Group of program instructions GPI03 including program instructions for causing the visual-enrichment-data distribution module 120 to retrieve the video segment 275, during the displaying of the content item 201 by the content playing device 141, wherein the retrieving includes accessing the strictly larger video content item 276 and reading the video segment 275 from within the strictly larger video content item 276 without reading other segments of the strictly larger video content item 276.
d. Group of program instructions GPI04 including program instructions for causing the visual-enrichment-data distribution module 120 to cause the playing of the video segment 275 by the content playing device 141.

We now refer to FIG. 6, a schematic representation of program instructions 160 according to some embodiments. The instructions relate to embodiments in which the determining of GPI02 includes accessing a database 135 that includes information about video segments 275 that are portions of strictly larger video content items 276 and content tags 277 related to the video segments 275. The program instructions 160 include the four groups of program instructions GPI01 . . . GPI04 discussed earlier with respect to FIG. 5, and two additional groups of program instructions: GPI05 and GPI06. Each group of program instructions includes program instructions for carrying out a portion of a method. The two additional groups comprise:
e. Group of program instructions GPI05 including program instructions for causing the visual-enrichment-data distribution module 120 to associate video segments 275 of video content items 276 included in a repository 134 of video content items 276 with content tags 277, each video segment 275 being a portion of a strictly larger video content item 276 included in the repository 134.
f. Group of program instructions GPI06 including program instructions for causing the visual-enrichment-data distribution module 120 to store, in database 135, results of the associating caused by the execution of the group of program instructions GPI05, the results including an association of the video segment 275 with a content tag 277 related to the video segment 275.

According to the embodiments, the displaying of the content item 201 by the content playing device 141 caused by the execution of the group of program instructions GPI01 is subsequent to the associating and the storing caused by the execution of groups of program instructions GPI05 and GPI06.

We now refer to FIG. 7, a schematic representation of program instructions 160 according to some embodiments. The program instructions 160 include the four groups of program instructions GPI01 . . . GPI04 discussed earlier with respect to FIG. 5, and two additional groups of program instructions: GPI07 and GPI08. Each group of program instructions includes program instructions for carrying out a portion of a method. The two additional groups comprise:
e. Group of program instructions GPI07 including program instructions for causing the visual-enrichment-data distribution module 120 to receive, during the displaying of the content item 201 by the content playing device 141, a request from the user 90 to propose enrichment data that is connected to the content item 201.
f. Group of program instructions GPI08 including program instructions for causing the visual-enrichment-data distribution module 120 to present the user 90, subsequent to the receiving of the request by the execution of the group of program instructions GPI07, with an option to select the video segment 275. The playing of the video segment 275 caused by the execution of GPI04 is performed only in response to the user 90 activating the option.

We now refer to FIG. 8, a schematic representation of program instructions 160 according to some embodiments. The program instructions 160 include the four groups of program instructions GPI01 . . . GPI04 discussed earlier with respect to FIG. 5, and one additional group of program instructions: GPI09. Each group of program instructions includes program instructions for carrying out a portion of a method. The additional group comprises:
e. Group of program instructions GPI09 including program instructions for causing the visual-enrichment-data distribution module 120 to present the user 90, during the displaying of the content item 201 by the content playing device 141, with an option to select the video segment 275, wherein the playing of the video segment 275 caused by the execution of group of program instructions GPI04 is performed only in response to the user 90 activating the option.

Referring now to FIG. 9, a method is disclosed according to embodiments, for enhancing user experience for a user 90 consuming a content item 201. The method, as shown in the flow chart of FIG. 9, comprises the following steps:
a. Step S01, causing the content item 201 to be displayed by a content playing device 141.
b. Step S02, during the displaying of the content item 201 by the content playing device 141: (i) determining other content having a connection to the content item 201, where the determined other content includes a video segment 275 that is a portion of a strictly larger video content item 276, and (ii) retrieving the video segment 275, wherein the retrieving includes accessing the strictly larger video content item 276 and reading the video segment 275 from within the strictly larger video content item 276 without reading other segments of the strictly larger video content item 276. In some embodiments, the determining includes accessing a database 135 that includes information about video segments 275 that are portions of strictly larger video content items 276 and content tags 277 related to the video segments 275. In some embodiments, the connection of the video segment 275 to the content item 201 includes a connection between a content tag 277 related to the video segment 275, and the content item 201.
c. Step S03, causing the playing of the video segment 275 by the content playing device 141.

Any of the steps in the method, and in fact any of the steps in any of the methods disclosed herein, can be implemented in a system 100 for distributing video content as disclosed herein.

Referring now to FIG. 10, a method is disclosed according to some embodiments, for enhancing user experience for a user 90 consuming a content item 201. The method relates to embodiments in which the determining includes accessing a database 135 that includes information about video segments 275 that are portions of strictly larger video content items 276 and content tags 277 related to the video segments 275. The method, as shown in the flow chart of FIG. 10, comprises Steps S01 through S03 of FIG. 9, and the following additional steps:
a. Step S04, associating video segments 275 of video content items 276 included in a repository 134 of video content items 276 with content tags 277, each video segment 275 being a portion of a strictly larger video content item 276 included in the repository 134.
b. Step S05, storing, in the database 135, results of the associating, the results including an association of the video segment with a content tag related to the video segment.
In the embodiments, the displaying of the content item 201 by the content playing device 141 is subsequent to the associating and the storing of Steps S04 and S05.

Referring now to FIG. 11, a method is disclosed according to some embodiments, for enhancing user experience for a user 90 consuming a content item 201. The method, as shown in the flow chart of FIG. 11, comprises Steps S01 through S03 of FIG. 9, and the following additional steps:
a. Step S06, during the displaying of the content item 201 by the content playing device 141, receiving a request from the user to propose enrichment data that is connected to the content item 201.
b. Step S07, subsequent to the receiving of the request, presenting the user with an option to select the video segment 275.

In these embodiments, the causing of the playing of the video segment 275 is performed only in response to the user activating the option.

Referring now to FIG. 12, a method is disclosed according to some embodiments, for enhancing user experience for a user 90 consuming a content item 201. The method, as shown in the flow chart of FIG. 12, comprises Steps S01 through S03 of FIG. 9, and the following additional step:
a. Step S08, during the displaying of the content item 201 by the content playing device 141, presenting the user 90 with an option to select the video segment 275, wherein the causing of the playing of the video segment 275 is performed only in response to the user 90 activating the option.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

### Definitions

This disclosure should be interpreted according to the definitions below.

In case of a contradiction between the definitions in this Definitions section and other sections of this disclosure, this section should prevail.

In case of a contradiction between the definitions in this section and a definition or a description in any other document, including in another document included in this disclosure by reference, this section should prevail, even if the definition or the description in the other document is commonly accepted by a person of ordinary skill in the art.
1. “content”—information and experiences that are directed towards an end-user or audience.
2. “content item”—a stand-alone unit of content that can be referred to and identified by a single reference and can be retrieved and played independently of other content. For example, a movie, a still image, or a paragraph of text.
3. “media content item”—a content item that contains media content. For example, a movie, a TV program, an episode of a TV series, a video clip, an animation, an audio clip, or a still image.
4. “non-media content item”—a content item that is not a media content item. For example, a paragraph of text.
5. “audio content item”—a media content item that contains only an audio track hearable using a speaker or a microphone.
6. “video content item”—a media content item that contains a visual track viewable on a screen. A video content item may or may not additionally contain an audio track.
7. “audio” and “aural” are used as synonyms herein.
8. “video” and “visual” are used as synonyms herein.
9. “audio channel” and “audio track” are used as synonyms herein. Both refer to an audio component of a media content item.
10. “video channel” and “video track” are used as synonyms herein. Both refer to a video component of a media content item. A still image is a special case of video track.
11. “content playing device”—a device that is capable of playing or displaying at least some content items. For example, a graphic engine that is capable of displaying paragraphs of text, a combined video/audio player that is capable of playing in parallel both the video channel and the audio channel of at least some media content items.
12. “media playing device”—a device that is capable of playing at least some media content items. For example, an audio-only player that is capable of playing at least some audio content items, a video-only player that is capable of playing the video track of at least some video content items, a combined video/audio player that is capable of playing in parallel both the video channel and the audio channel of at least some media content items.
13. “playing a media content item”—outputting at least one of a video channel and an audio channel of the media content item to a visual output device (for example a TV screen) or an audio output device (for example a speaker or headphones). If the media content item is a still image, then playing it means outputting the still image to a visual output device. If the media content item is a video content item that has both a video channel and an audio channel, then playing it means outputting both the video channel and the audio channel to a visual output device and an audio output device, respectively. Pausing a video content item in the middle of playing is considered playing it. Also, showing the last frame of a video content item after it was played to its end is considered playing the video content item.
14. “displaying a media content item”—outputting a video channel of the media content item to a visual output device (for example a TV screen). If the media content item is a still image, then displaying it means outputting the still image to a visual output device. Pausing a video content item in the middle of playing it is considered displaying it. Also, showing the last frame of a video content item after it was played to its end is considered displaying the video content item.
15. “displaying a non-media content item”—outputting a visual image of the non-media content item to a visual output device (for example outputting a visual image of a paragraph of text to a computer screen).
16. “entity”—something that exists as itself, as a subject or as an object, actually or potentially, concretely or abstractly, physically or not. It need not be of material existence. In particular, abstractions and legal fictions are regarded as entities. There is also no presumption that an entity is animate, or present. Specifically, an entity may be a person entity, a location entity, an organization entity, a media content item entity, a topic entity or a group entity. Note that the term “entity” does not refer to the text referencing the subject or the object, but to the identity of the subject or the object.
17. “person entity”—a real person entity, a character entity or a role entity.
18. “real person entity”—a person that currently lives or that had lived in the past, identified by a name (e.g. John Kennedy) or a nickname (e.g. Fat Joe).
19. “character entity”—a fictional person that is not alive today and was not alive in the past, identified by a name or a nickname. For example, “Superman”, “Howard Roark”, etc.
20. “role entity”—a person uniquely identified by a title or by a characteristic. For example “the 23^{rd} president of the United States”, “the oldest person alive today”, “the tallest person that ever lived”, “the discoverer of the penicillin”, etc.
21. “location entity”—an explicit location entity or an implicit location entity.
22. “explicit location entity”—a location identified by a name (e.g. “Jerusalem”, “Manhattan 6^{th} Avenue”, “Golani Junction”, “the Dead Sea”) or by a geographic locator (e.g. “ten kilometers north of Golani Junction”, “100 degrees East, 50 degrees North”).
23. “implicit location entity”—a location identified by a title or a by a characteristic (e.g. “the tallest mountain peak in Italy”, “the largest lake in the world”).
24. “organization entity”—an organization identified by a name (e.g. “the United Nations”, “Microsoft”) or a nickname (e.g. “the Mossad”).
25. “media content item entity”—A media content item identified by a name (e.g. “Gone with the Wind” is a media content item entity that is a movie, and “Love Me Do” is a media content item entity that is a song).
26. “topic entity”—a potential subject of a conversation or a discussion. For example, the probability that Hillary Clinton will win the presidential election, the current relations between Russia and the US, the future of agriculture in OECD countries.
27. “group entity”—a group of entities of any type. The different member entities of a group may be of different types.
28. “nickname of an entity”—any name by which an entity is known which is not its official name, including a pen name, a stage name and a name used by the public or by a group of people to refer to it or to address it.
29. “named entity”—An entity that is identified by a name or a nickname and not by other types of description. For example, “Jerusalem” is a named entity, but “the tallest building in Jerusalem” is not a named entity (even though it is a perfectly valid entity, that is uniquely identified).
30. “NEW” or “Named Entity Recognition”—The task of recognizing the occurrence of a reference to a named entity within a text, without necessarily identifying the identity of the specific named entity referred to by the reference.
31. “NED” or “Named Entity Disambiguation”—The task of determining the identity of a specific named entity referred to by a reference to a named entity occurring in a text, when the reference can match the identities of multiple candidate named entities. The disambiguation results in assigning one of the identities of the multiple candidate named entities to the reference occurring in the text. Note that the task of Named Entity Disambiguation also includes the initial step of determining that an occurrence of a reference to a named entity is ambiguous and requires disambiguation. However, the task of Named Entity Disambiguation does not include the determining of the identity of a specific named entity when the occurrence of the reference to the named entity in the text can only match the identity of a single named entity, as there is no need for disambiguation in such case.
32. “ambiguous reference to a named entity”—An occurrence of a reference to a named entity in a text that can match the identities of multiple candidate named entities.
33. “ambiguous named entity”—A short way of saying “ambiguous reference to a named entity”, without explicitly mentioning the reference to the named entity. Note that, strictly speaking, the term is not accurate, because it is not the named entity that is ambiguous but the reference to the named entity, and therefore the term should always be understood as referring to an implicit reference to the named entity.
34. “disambiguating a reference to a named entity”—The operation of assigning an identity of a specific named entity to an ambiguous reference to a named entity occurring in a text.
35. “disambiguating a named entity”—A short way of saying “disambiguating a reference to a named entity”, without explicitly mentioning the reference to the named entity. Note that, strictly speaking, the term is not accurate, because it is not the named entity that is being disambiguated but the reference to the named entity, and therefore the term should always be understood as referring to an implicit reference to the named entity.
36. “subtitles”—Text derived from either a transcript or a screenplay of a dialog or commentary in movies, television programs and the like, displayable on the screen while the movie or program is being played. Subtitles can either be a translation of text spoken in the movie or program into a different language, or a rendering of text in the same language spoken in the movie or program. Subtitles may include added information to help viewers who are deaf or hard of hearing to follow the dialog or commentary, or to help people who cannot understand the spoken dialogue or commentary, or who have accent recognition problems. The subtitles can either be pre-rendered with the video or separately provided as either graphics or text to be rendered and overlaid by a rendering device.
37. “OCR” or “Optical Character Recognition”—The mechanical or electronic conversion of images of typed, handwritten or printed text into machine-encoded text, whether from a scanned document, a photo of a document, a scene-photo (for example the text on signs and billboards in a landscape photo) or from subtitles text superimposed on an image (for example from a television broadcast).
38. “speech-to-text conversion”—A process by which spoken language is recognized and translated into machine-encoded text by computers. It is also known as “automatic speech recognition” (ASR), “computer speech recognition”, or just “speech to text” (STT).
39. “video shot” (also referred to herein as “shot”)—A continuous sequence of frames within a video content item that were continuously recorded by the same camera. A video shot is a physical entity that does not deal with the semantic meaning of its content.
40. “video scene” (also referred to herein as “scene”)—A collection of one or more semantically-related and temporally adjacent video shots depicting and conveying a high-level concept or story. In other words, a video scene is a semantic entity that is a continuous portion of a video content item and has an independent identity of its own. For example, one news item of a news program or a car chase scene of an action movie. Typically there are multiple video scenes within a video content item, but a video scene may also be the only one within its video content item, as may be the case for a short music video clip.
41. “video segment” (also referred to herein as “segment”)—a continuous portion of a video content item that is strictly smaller than the enclosing video content item. A video segment may coincide with a video shot or with a video scene, but does not have to. That is—a video segment may be a single shot, multiple shots, a portion of a shot, multiple shots plus a portion of a shot, a single scene, multiple scenes, a portion of a scene, or multiple scenes plus a portion of a scene.

It should be emphasized that a video segment extracted from its enclosing video content item and put back into a library or collection of video content items as a stand-alone video item, is no longer considered to be a video segment and becomes a video content item of its own. This is so even if the enclosing video content item from which the segment was extracted is available in the same library or collection. That is, a car chasing scene extracted from a movie and posted as a short video in YouTube is no longer a video segment for the purpose of the present solution.
42. “strictly larger”—larger and not equal to.

1. A method for enhancing user experience for a user consuming a content item, comprising:
a. causing the content item to be displayed by a content playing device;
b. during the displaying of the content item by the content playing device:
i. determining other content having a connection to the content item, where the determined other content includes a video segment that is a portion of a strictly larger video content item, and
ii. retrieving the video segment, wherein the retrieving includes accessing the strictly larger video content item and reading the video segment from within the strictly larger video content item without reading other segments of the strictly larger video content item; and
c. causing the playing of the video segment by the content playing device.

2. The method of claim 1, wherein:
i. the determining includes accessing a database that includes information about video segments that are portions of strictly larger video content items and content tags related to the video segments, and
ii. the connection of the video segment to the content item includes a connection between a content tag related to the video segment, and the content item.

3. The method of claim 2, additionally comprising:
d. associating video segments of video content items included in a repository of video content items with content tags, each video segment being a portion of a strictly larger video content item included in the repository; and
e. storing, in the database, results of the associating, the results including an association of the video segment with the content tag related to the video segment,
wherein the displaying of the content item by the content playing device is subsequent to the associating and the storing.

4. The method of claim 1, wherein the content item includes a media content item.

5. The method of claim 4, wherein the media content item includes a video content item.

6. The method of claim 1, wherein the content item includes a non-media content item.

7. The method of claim 6, wherein the non-media content item includes a paragraph of text.

8. The method of claim 1, wherein the connection of the video segment to the content item is selected from the group of connections consisting of a connection of the video segment to the content item as a whole, a connection of the video segment to a scene in the content item, and a connection of the video segment to a named entity identified in the content item.

9. The method of claim 1, wherein the determining of the other content having a connection to the content item includes analyzing a video channel of the content item.

10. The method of claim 1, wherein the determining of the other content having a connection to the content item includes analyzing an audio channel of the content item.

11. The method of claim 1, wherein the determining of the other content having a connection to the content item includes analyzing subtitles of the content item.

12. The method of claim 1, wherein the determining of the other content having a connection to the content item includes analyzing metadata of the content item.

13. The method of claim 1, wherein the determining of the other content having a connection to the content item includes analyzing text included in the content item.

14. The method of claim 1, wherein the determining of the other content having a connection to the content item is based on user preferences obtained by analyzing viewing history of the user.

15. The method of claim 1, wherein the playing of the video segment is done while the content item is being displayed by the content playing device.

16. The method of claim 1, wherein for at least one point in time the content item and the video segment are simultaneously displayed.

17. The method of claim 1, wherein the content item is a video content item and the displaying of the content item is paused while the video segment is played.

18. The method of claim 1, further comprising:
d. during the displaying of the content item by the content playing device, receiving a request from the user to propose enrichment data that is connected to the content item; and
e. subsequent to the receiving of the request, presenting the user with an option to select the video segment,
wherein the causing of the playing of the video segment is performed only in response to the user activating the option.

19. The method of claim 1, further comprising:
d. during the displaying of the content item by the content playing device, presenting the user with an option to select the video segment, wherein the causing of the playing of the video segment is performed only in response to the user activating the option.

20. A system for distributing video content, comprising:
a. a content-item distribution module;
b. a visual-enrichment-data distribution module;
c. one or more computer processors; and
d. a non-transitory computer-readable storage medium storing program instructions for execution by the one or more computer processors, the non-transitory computer-readable storage medium having stored therein:
i. first program instructions that, when executed by the one or more processors, cause the content-item distribution module to cause the displaying of a content item by a content playing device;
ii. second program instructions that, when executed by the one or more processors, cause the visual-enrichment-data distribution module to determine, during the displaying of the content item by the content playing device, other content having a connection to the content item, where the determined other content includes a video segment that is a portion of a strictly larger video content item;
iii. third program instructions, that, when executed by the one or more processors, cause the visual-enrichment-data distribution module to retrieve the video segment, wherein the retrieving includes accessing the strictly larger video content item and reading the video segment from within the strictly larger video content item without reading other segments of the strictly larger video content item; and
iv. fourth program instructions that, when executed by the one or more processors, cause the visual-enrichment-data distribution module to cause the playing of the video segment by the content playing device.
